(19) United States
(12) Patent Application Publication
(10) Pub. No.: US 2014/0199447 A1
(43) Pub. Date: Jul. 17, 2014

(54) SYSTEM AND METHOD FOR CONTINUOUSLY COATING CONFECTIONARY PRODUCT

(71) Applicant: KRAFT FOODS GLOBAL BRANDS LLC, Northfield, IL (US)

(72) Inventors: Cesar C. Elejalde, Whippany, NJ (US); Miles Van Niekerk, Whippany, NJ (US); Gerald B. Cotten, Whippany, NJ (US)

(73) Assignee: INTERCONTINENTAL GREAT BRANDS LLC, East Hanover, NJ (US)

(21) Appl. No.: 14/119,935

(22) PCT Filed: May 30, 2012
(86) PCT No.: PCT/US2012/039973

§ 371 Date: Feb. 24, 2014

Related U.S. Application Data
(60) Provisional application No. 61/495,451, filed on Jun. 10, 2011.
(60) Provisional application No. 61/491,759, filed on May 31, 2011.

(51) Int. Cl. A23G 3/34

(52) U.S. Cl. CPC A23G 3/0089; A23G 3/0085
USPC 426/291; 118/16; 426/293

(57) ABSTRACT

Disclosed is a system for continuously coating individual pieces of confectionary product, the system including a product feed device, at least one drum coating arrangement configured to continuously receive the individual pieces of confectionary product from the product feed device, the drum coating arrangement including a first rotating drum rotatable about a first drum axis and a second rotating drum rotatable about a second drum axis, a first drum volume defined by the first rotating drum, and a second drum volume defined by the second rotating drum, the first drum volume being communicable with the second drum volume, wherein the drum coating arrangement is configured such that the confectionary product has a longer residence time in the second drum volume than the first drum volume.

### FIELD

The disclosure generally relates to a continuous coating of pieces or cores of confectionary product, and more particularly to a continuous coating of pieces or cores of confectionary product via a drum coating arrangement.

### BACKGROUND

There are numerous known processes for coating gum and confectionary products. These processes include batch-type and continuous coating.

For batch-type processes, large rotating containers are utilized to coat confectionary cores or pieces (particularly gum cores or pieces). Initially, the confectionary material may be produced by a standard extrusion or batch processes and formed into rope or large thin sheets of material several inches or a foot or more in width. Separation lines are pressed or formed into the sheets, thereby forming the shapes of the smaller pieces (i.e. “cores”). The material may then be stored in a cooler or under a cooled atmosphere in order to condition them for further processing.

Pursuant to more recent batch-type processes, the confectionary material is dumped into rotating mixers and separated into cores by a tumbling process. Thereafter, a coating solution, such as a sugar syrup, is added to the mixer during mixer rotation. Hot air at a temperature of approximately 120° F. is further applied to dry the coated cores.

In order to form a uniform and consistent coated gum product with a coat of the desired thickness, this process is repeated numerous times until completion of the requisite coating. In order to achieve an acceptable coating, the process is repeated up to 40-50 times with small, thin layers being added each time. This process can take up to 6-7 hours to complete, and involve a good deal of labor.

In an effort to provide an improved upon and more efficient coating process over the batch-type processes discussed above, continuous coating processes have been developed. In such processes, small cores or pieces of confectionary material (particularly gum) are introduced into one or more rotating cylindrical drums. Therein, the pieces are lightly coated with a sugar solution. A continuous flow of heated air is circulated through the drums and dries the coating solution on the gum cores at the same time that the material is being coated. Conduits or conveyors are utilized to interconnect the drums and transport the material being coated from one drum to the other.

The above processes being described, it should be noted that some types of confectionary may desirably call for a coating that is applied in multiple layers, with each layer including compositional differences. As such compositionally different layers may interact differently with the core confectionary pieces to which they are applied (i.e. be absorbed by the cores or bind to the cores at different rates), it may be inefficient to apply coating layers in a single drum or multiple drums that are identically configured and operated. For instance, certain confectionery cores, such as chewy candy cores, and particularly powder-filled chewy candy cores, are delicate in nature. Application of a hard outer coating to such delicate cores can be problematic as the cores may be crushed or collapse under the product weight tumbling in typical batch-type hard coating pans. Accordingly, it may be desirable to coat such cores with a soft pre-coating prior to a subsequent hard outer coating. This can provide a final coated chewy candy product that is more stable than if it were simply hard pan coated alone. Application of such a soft pre-coating may involve applying a liquid material in one drum and a powder material in a second drum, which binds to the liquid material to form the soft coating layer on the chewy candy cores. In such a process, it may be desirable to have a longer residence time in the second drum so that the powder material has sufficient time to bind to the liquid material. Accordingly, a system and method that allows for variation in drum interaction with core confectionary pieces would be desirable.

### SUMMARY

Disclosed is a system for continuously coating individual pieces of confectionary product, the system including a product feed device, at least one drum coating arrangement configured to continuously receive the individual pieces of confectionary product from the product feed device, the drum coating arrangement including a first rotating drum rotatable about a first drum axis and a second rotating drum rotatable about a second drum axis, a first drum volume defined by the first rotating drum, and a second drum volume defined by the second rotating drum, the first drum volume being communicable with the second drum volume, wherein the drum coating arrangement is configured such that the confectionary product has a longer residence time in the second drum volume than the first drum volume.

Also disclosed is a method for continuously coating individual pieces of confectionary product, the method including continuously feeding the individual pieces of confectionary product from a product feed device into at least one drum coating arrangement, the drum coating arrangement including a first rotating drum and a second rotating drum, transporting the individual pieces of confectionary product through a first drum volume defined by the first rotating drum, the transporting through the first drum volume occurring in a first residence time, applying a first material to the individual pieces of confectionary product during the first residence time, transferring the individual pieces of confectionary product from the first drum volume to a second drum volume defined by the second rotating drum, transporting the individual pieces of confectionary product through the second drum volume, the transporting through the second drum volume occurring in a second residence time, the second residence time being longer than the first residence time, and applying a second material to the individual pieces of confectionary product during the second residence time.

### BRIEF DESCRIPTION OF THE DRAWINGS

The accompanying drawings incorporated in and forming a part of the specification embodies several aspects of the present invention and, together with the description, serve to explain the principles of the invention. In the drawings:

FIG. 1 is a schematic plan view of a system for continuously coating individual pieces of confectionary product in accordance with an exemplary embodiment;

FIG. 2 is a schematic perspective view of the system in accordance with the exemplary embodiment shown in FIG. 1;

FIG. 3 is a schematic front elevation view of the system in accordance with the exemplary embodiment shown in FIG. 1;

FIG. 4 is a schematic side elevation view of the system in accordance with the exemplary embodiment shown in FIG. 1;

FIG. 5 is a partial and schematic perspective view of the system in accordance with the exemplary embodiment shown in FIG. 1;

FIG. 6 is a partial and schematic cross-sectional view of the system in accordance with the exemplary embodiment shown in FIG. 1;

FIG. 7 is another partial and schematic cross-sectional view of the system in accordance with the exemplary embodiment shown in FIG. 1;

FIG. 8 is an alternative partial and schematic cross-sectional view of the system in accordance with the exemplary embodiment shown in FIG. 1;

FIG. 9 is a further alternative partial and schematic cross-sectional view of the system in accordance with the exemplary embodiment shown in FIG. 1; and

FIG. 10 is a partial and schematic perspective view of the system in accordance with the exemplary embodiment shown in FIG. 1.

### DETAILED DESCRIPTION

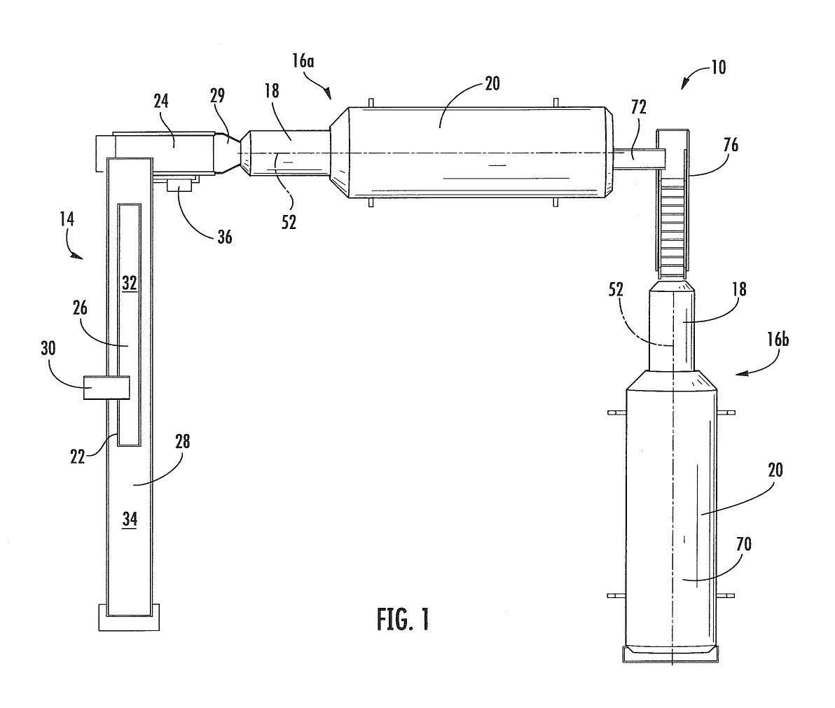

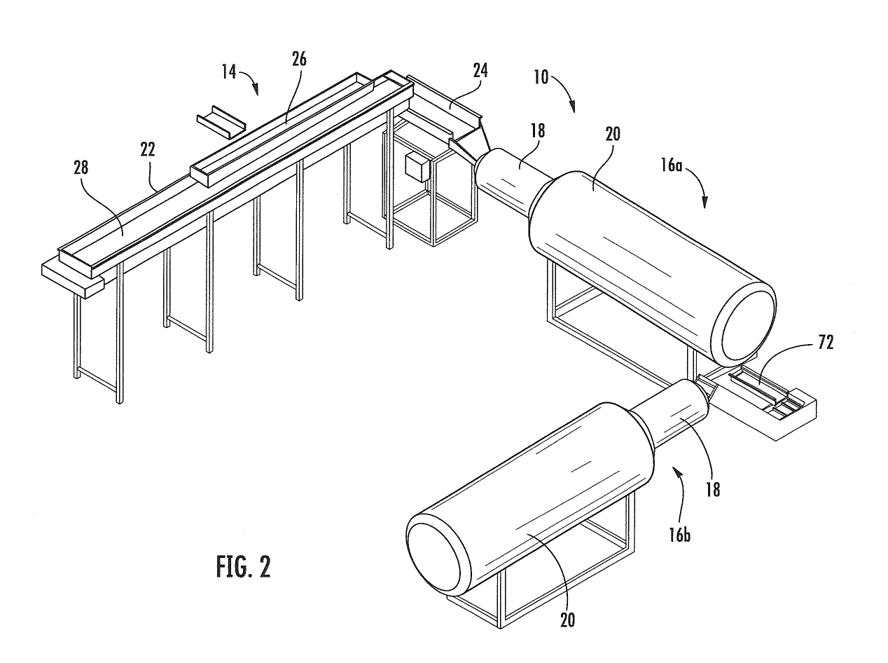

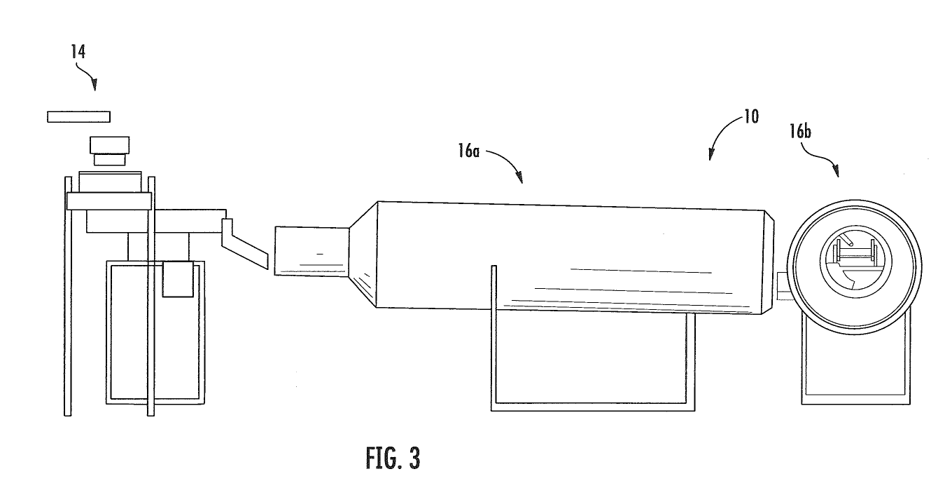

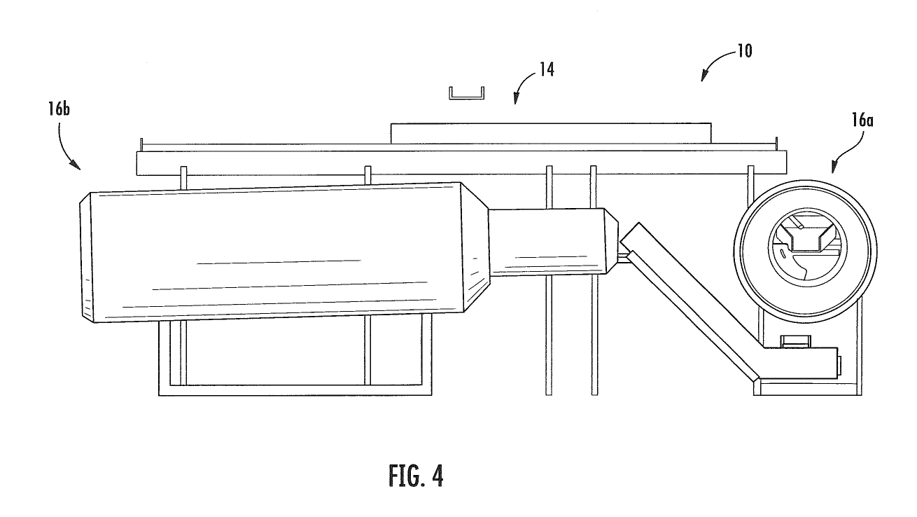

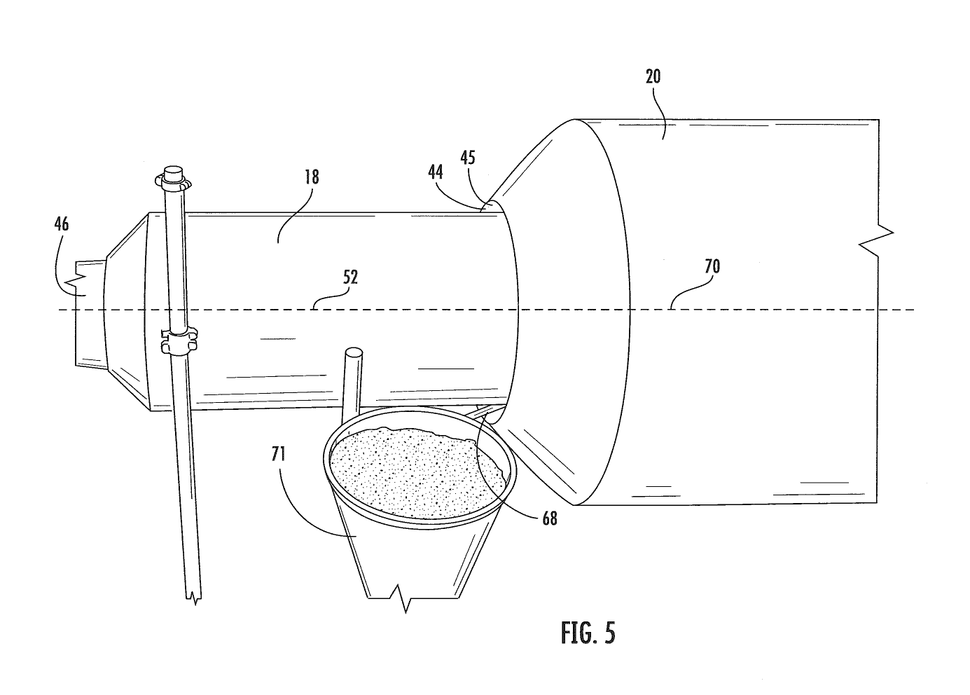

Referring to FIGS. 1-10, a system 10 for continuously coating individual pieces 12 of confectionary product via agglomeration is shown. Referring first to FIGS. 1-3, the system 10 generally includes a product feed device 14 and at least one drum coating arrangement 16a, 16b, which each include a first rotating drum 18 and a second rotating drum 20. These components and the manner in which they interact in order to coat the confectionary pieces 12 will be discussed in greater detail hereinbelow.

The confectionary pieces 12 enter the system 10 at the product feed device 14. In an exemplary embodiment shown generally in FIGS. 1-4, the feed device 14 includes an accumulator 22 and a feeder 24. The accumulator 22 and the feeder 24, in conjunction with the other elements of the feed device 14 (these elements being discussed in greater detail below), control an amount of product (i.e. pieces 12) that enter the drum coating arrangement 16a. Such control (as implemented by the computer(s) discussed below) is facilitated by allowing the product to enter feed device 14 via a first tray 26 and a second tray 28 of the accumulator 22, and maintaining a desirable amount of the product at a desirable height or depth within the trays prior to entering the feeder 24.

In the exemplary embodiment of FIGS. 1-4, product is supplied to the first tray 26 via an elevating conveyor and depositing device 30 (shown schematically in the Figures). As the device 30 deposits the product on the first tray 26, the tray slides back and forth over the second tray 28 (via a wheel and guide rail system in an exemplary embodiment), transporting the product to the lower tray 28 at areas of lesser or no product depth. This transfer occurs via a conveyor 32 disposed on the first tray 26, whereby the first tray 26 is actuated to slide over an area of lesser depth in the second tray 28, and the conveyor 32 (which can move in either direction and transport product over either edge) moves to transfer the product over an edge of the first tray 26 and down into the second tray 28. After the product has been deposited in a particular area to a desirable height or depth, the first tray 26 may move or slide to another area over the second tray 28 with a lesser depth. An electronic eye that extends from the first tray 26 (at one or both sides of the tray 26) may be used to monitor height/depth of the product within the second tray.

Once deposited to a desirable depth across a desired length of the second tray 28, a conveyor 34 disposed on the second tray 28 transports the product to the feeder 24. Therein, weight of the product is monitored via an electronic scale 36 disposed under the feeder 24, with the amount of product initially entering the feed device 14 being ultimately conveyed in a continuous flow from the feeder 24 to a chute 29 connecting the feeder to the drum coating arrangement 16a.

It should be noted that actuation of the first tray 26, the conveyors 32,34, the scale 36, the depositing device 30, and the desirable depth to which the first tray 26 deposits product in the second tray 28 are controllable via a computer micro-processor or micro-processors in communication with the various components of the feed device 14 individually or as a whole. These computer(s) may control or communicate with a remainder of the components of the system 10. Product height in the second tray may also be communicated to the computer(s) from devices such as the electronic eye mentioned above. In an exemplary embodiment, the product is deposited across a substantially entirety of the second tray length at a height/depth of approximately 6 to 10 inches. The product is then conveyed from the second tray to the feeder 24, where it is maintained at a desirable height/depth of 1 to 10 inches, as it is further conveyed from the feeder 26 to the chute 29.

Having been desirably accumulated in the feed device 14, the product may now be continuously fed down the chute 29 and into the drum coating arrangement 16a. As shown in FIGS. 1-4 and 5-6 in particular, the arrangement 16a (as well as 16b, which is configured similarly arrangement 16a) includes a first rotating drum 18 and a second rotating drum 20. These drums 18 and 20 may be fixed relative to each other (in the exemplary positions shown in the Figures) via any known affixing or locking mechanism, the mechanism affixing the drums via connection to surfaces of the drums or structures supporting the drums.

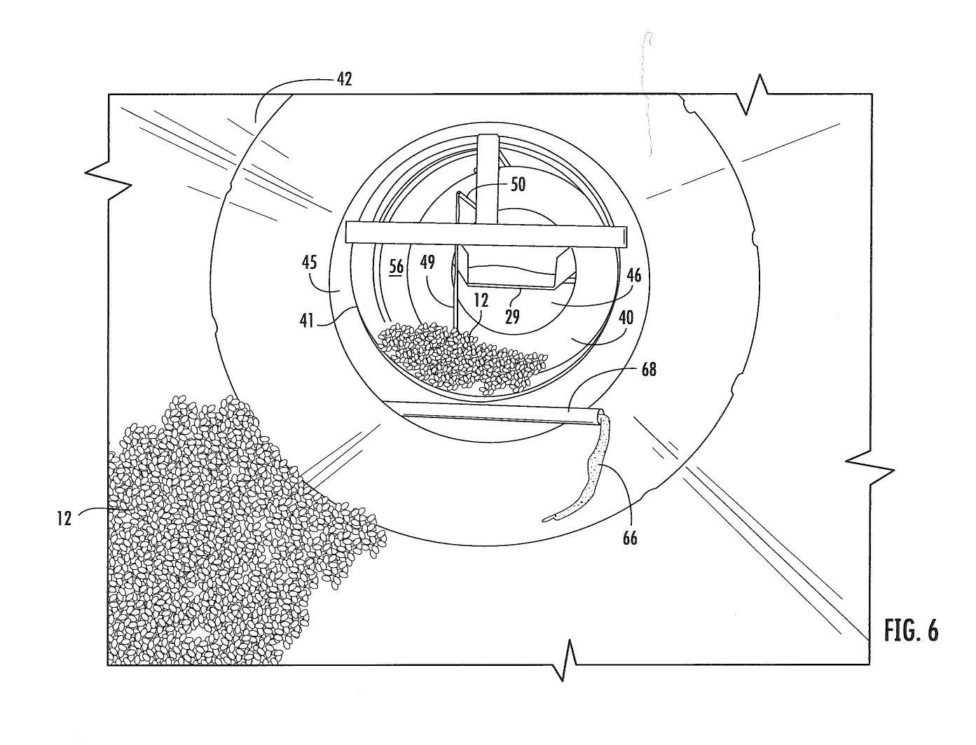

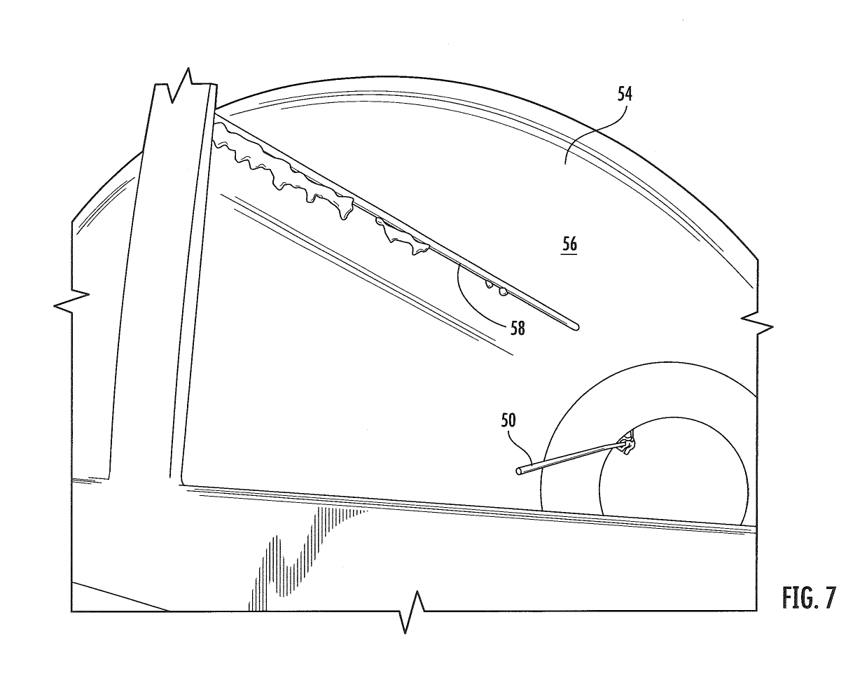

In addition, and as is best shown in FIG. 6, the first drum defines a first drum volume 40, and the second drum defines a second drum volume 42. In the exemplary embodiment of FIGS. 6 and 7, the drum volumes 40 and 42 communicate via insertion of an end 41 of the first drum 18 into a portion of the second drum 20 that tapers down to an inlet opening 44 thereof, allowing the pieces 12 to flow from the first drum 18 into the second drum 20. This insertion of the end 41 of the first drum 18 into the inlet opening 44 of the second drum 20 also forms an annulus 45 between the drums.

During transport of the pieces 12 from an inlet opening 46 in the first drum 18 (and thus an inlet into the drum arrangement 16a in general) to an outlet opening 48 of the second drum 20 (and thus an outlet from the drum arrangement 16a in general), the pieces 12 will have a longer residence time in the second drum volume 42 than the first drum volume 40 (with each pieces 12 desirably having substantially the same residence time in each drum 18 and 20 to facilitate consistent coating). In an exemplary embodiment, the longer residence time in the second drum volume 42 is achievable because the drums 18, 20 are configured such that the second drum volume 42 is greater than the first drum volume 40 via a greater diameter and/or length of the second drum 20 relative to the first drum 18.

Residence time within each drum is important in the system 10 as described below because of the different materials applied to the pieces 12 of product in the first drum 18 and the second drum 20. Referring first to the first drum 18, a liquid material 49 is desirably chosen for feed into the first drum volume 40. This material may be any conventional sugar-based or sugar-free syrup material that will act as a coating or binding solution, and is fed into the first drum volume 40 via at least one nozzle 50 that is best shown in FIG. 6. It is important that the pieces 12 include a relatively lesser residence time in this drum so that the syrup 49 being fed by the nozzle 50 is not absorbed by the pieces 12. The nozzle 50 extends to deliver the material 49 into the first drum volume 40 via the inlet opening 46 of the first drum 18 (at a tapered front portion thereof). Therein, the nozzle 50 feeds the liquid material 49 into the drum volume 40 via at least one of a dripping, drizzling, or spraying of the liquid material 49 from at least one dispensing point disposed an end and/or body (with openings defined along the body) of the nozzle 50. The nozzle 50 and/or apparatus supporting the nozzle and connecting the nozzle to a liquid supply (not shown) are configured such that a liquid material dispensing point(s) defined by the nozzle is positionally adjustable along an entire length of the first drum 18, allowing syrup output to occur anywhere along an entire length of the first drum 18. In an exemplary embodiment, the dispensing point is at the end of the nozzle 50, and positioned at a depth of approximately 25% to 75% into the first drum 18 (i.e. the dispensing end of the nozzle extends into the drum to a distance of approximately 25% to 75% of the drum length).

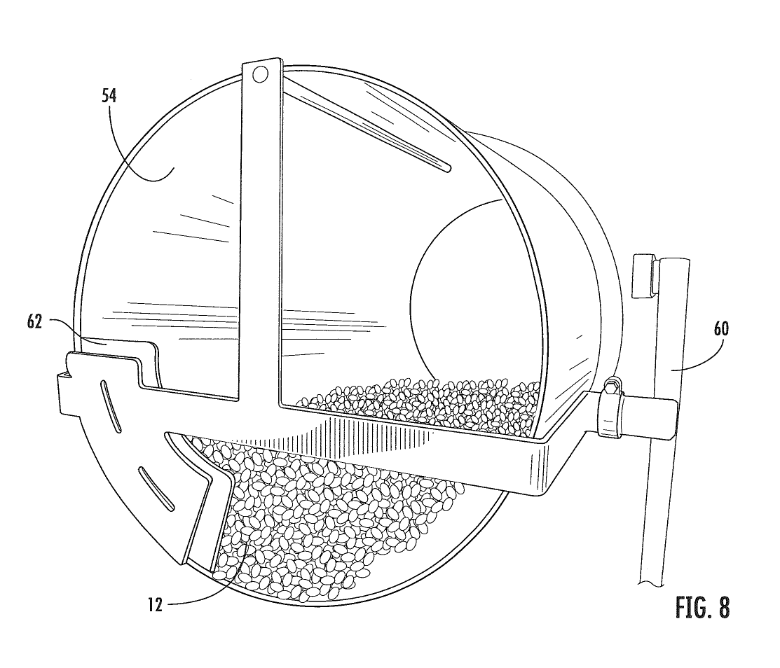

As the first drum 18 rotates about a central first drum axis 52, the liquid material 49 coats the pieces 12 about a surface thereof. The pieces 12 are transported from the inlet opening 46 to an outlet opening 54 via an incline of the first drum 18, wherein the inlet opening 46 is higher than the outlet opening 54. During this rotational transportation through the first drum volume 40, the liquid material 49 coats the pieces 12. However, due to potentially adherent qualities of the liquid material 49, some of the pieces 12 may become lodged to an inner surface 56 of the first drum 18. In order to dislodge the adhered pieces 12, a release assist bar 58 is positioned so as to extend into the first drum volume 18 via the outlet opening 54 (as shown in FIGS. 7 and 8). However, the release assist bar 58 could be configured in other manners, such as extending into the first drum volume 18 via the inlet opening 46. The bar 58 is positioned within the first drum volume 40 to be substantially parallel to the central first drum axis 52 and in proximity to the inner surface 56 (at a relatively upper portion thereof in FIGS. 7 and 8) of the first rotating drum 18. The proximity of the bar 58 to the inner surface 56 (the distance being less than a minor diameter of the pieces 12) allows the bar 58 to dislodge the pieces 12 that adhere to the inner surface 56, thereby knocking the pieces 12 down into a flow of the transported pieces 12 towards the outlet opening 54. In the exemplary embodiment of FIGS. 7 and 8, the bar 58 is affixed at or in proximity to an outlet opening end of the first drum 18 via a T-bar supported by mechanical fastening or welding to a first drum support structure 60 (though the T-bar or any other structure supporting the bar 58 may be affixed directly to the first drum 18).

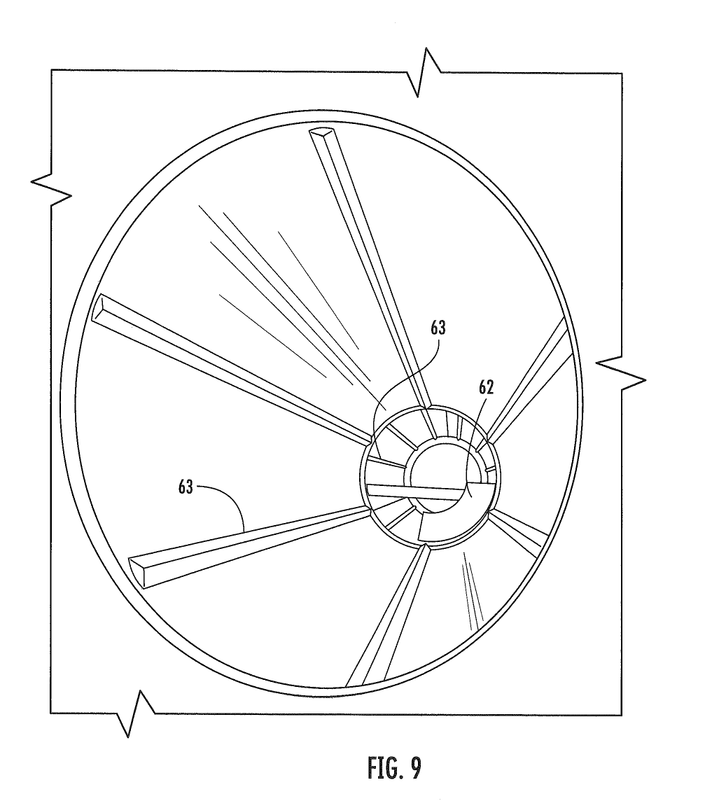

Also disposed at an outlet opening end of the first drum 18 in the exemplary embodiment of FIGS. 8 and 9 is a weir plate 62. The weir plate 62 (which may be constructed of Teflon or other such materials) is positioned between the first drum volume 40 and second drum volume 42, so as to desirably control product flow from the first drum volume 40 to the second drum volume 42. The weir plate 62 is removable and/or positionally adjustable along a circumferential perimeter of said first drum volume 40 (via rotation of the plate 62 and/or the first drum 18), and, like the bar 58, is affixed at or in proximity to an outlet opening end of the first drum 18 via a bar/plate device supported by mechanical fastening or welding to the first drum support structure 60 (though the bar device or any other structure supporting the plate 62 may be affixed directly to the first drum 18). This removability and/or adjustability allows for selective placement of the plate 62 into and out of a flow of the pieces 12 towards the second drum volume 42, thereby controlling the flow (i.e. impeding the flow) when present. Though the weir plate 62 is shown to be connected to the drum or support 60 via the same T-bar as the release assist 58, it should be appreciated that the weir plate 62 and release assist 58 may be connected to the drum or support 60 via different structures. As is shown in FIG. 9, inner surfaces of the drums 18 and 20 may also optionally include ribs 63 configured to facilitate coating of the pieces 12.

As the pieces 12 flow past the weir plate 62, the pieces 12 fall from the outlet opening 54 of the first drum 18, and into the second drum volume 42. The pieces 12 that enter the second drum volume 42 do so with the liquid material 49 having already been applied thereto. As is mentioned briefly above, insertion of the end 41 of the first drum 18 into the inlet opening 44 of the second drum 20 forms an annulus 45 between the drums. Importantly, this annulus 45 provides both an entry point for material into the second drum (see below), and a sampling point for analyzing liquid coated pieces 12 flowing from the first drum 18 to the second drum 20.

Referring now to the second drum 20, any conventional dry powder material 66 is desirably chosen for feed into the second drum volume 42 and application to the pieces 12. This material may be any conventional sugar-based or sugar-free dry/finely granulated material (such as bakers special sugar) that will adhere to the liquid material 49 that has already been applied to the pieces 12, and is fed into the second drum volume 42 via a powder tube 68 that is best shown in FIG. 6. It is important that the pieces 12 include a relatively longer residence time so that the powder material 66 may have sufficient time to bind to the liquid material 49 that has been applied to the pieces 12. The tube 68 extends into the second drum volume 42 via the annulus 45 between the first drum 18 and second drum 20. Therein, the tube 68 feeds the powder material 66 into the second drum volume 42 from an end and/or body (with opening defined along the body) of the tube 68. The tube 68 and/or apparatus supporting the tube 68 and connecting the tube 68 to a powder supply 71 are configured such that a powder material output(s) defined by the tube is positionally adjustable along an entire length of the second drum 20 allowing powder output to occur anywhere along an entire length of the second drum 20. In an exemplary embodiment, the output is at the end of the tube 68, and positioned as close as possible to an inlet end of the second drum 20.

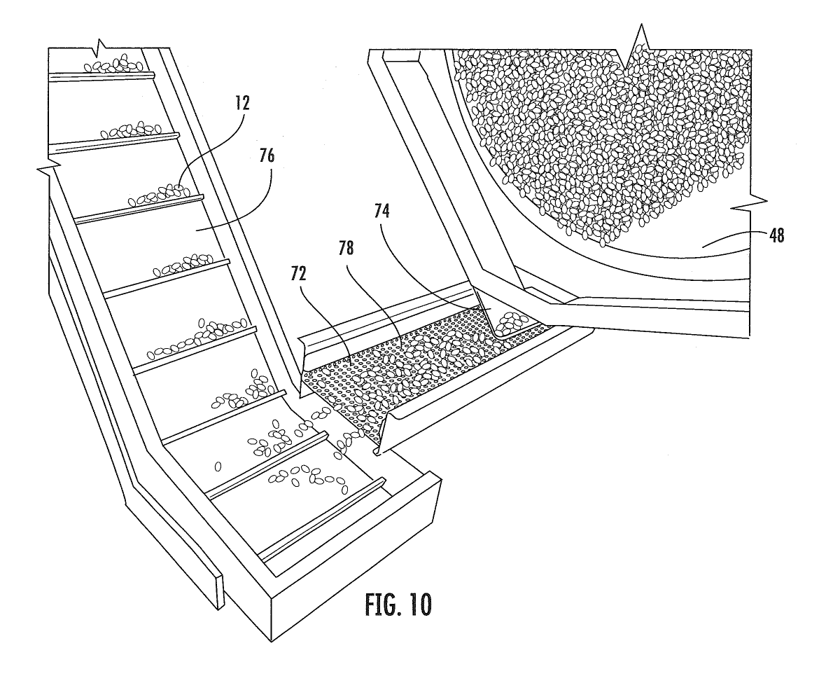

Similarly to the first drum 18, as the second drum 20 rotates about a central first drum axis 70, the pieces 12 of confectionary are coated with the powder material 66, whereby the powder material 66 binds to the liquid material 49 (from the first drum 18) that already coats the surface of the pieces 12. The pieces 12 are transported from an annulus position where the pieces 12 fall from the first drum 18 into the second drum volume 42 to an outlet opening 48 of the second drum 20 (the outlet opening being best shown in FIG. 10) via an incline of the second drum 20 that allows the annulus 45 to be higher than the outlet opening 48. This incline in the second drum 20 further allows the overall drum arrangement 16a to tilt downwards from the inlet opening 46 of the first drum 18, down to the annulus 45, and further down to the outlet opening 48 of the second drum 20. During the rotational transportation through the second drum volume 42, the powder material 66 coats the pieces 12, wherein the pieces leaving the second drum 20 are provided with a soft outer coating via a combination of liquid material 49 applied first directly to the pieces 12 and powder material 66 bound to the liquid material.

After exiting the second drum volume 42, if the system 10 includes multiple drum arrangements (as is the case with the exemplary system 10 shown in FIGS. 1-4, though the system 10 may include more or less than two arrangements) the pieces 12 (which now include a soft outer coating) are funneled to a scalper mechanism 72 that is best shown in FIG. 10. As the scalper mechanism 72 vibrates, the pieces 12 are transported from a funnel 74 to an elevator conveyor 76, which transports the pieces 12 to the next drum arrangement in series 16b. In addition, the vibration removes any excess powder from the pieces 12, the excess powder escaping the scalper 72 via staggered openings 78 disposed in the scalper 72. The pieces 12 travel up the conveyor 76 and into the arrangement 16b, which is substantially the same as arrangement 16a.

After exiting the final drum arrangement in the system (in the exemplary embodiment of FIGS. 1-4 that arrangement is arrangement 16b), the soft coated pieces 12 are gathered for conditioning. Conditioning occurs in an environment that prevents moisture absorption by the pieces 12, and may include transporting the soft coated pieces 12 to an area of reduced temperature and humidity relative to a temperature and humidity within the drums and in an ambient environment of the drum coating arrangements 16a, 16b. In an exemplary embodiment, this conditioning can occur for 18-48 hours and is believed to cure the soft coating applied to the pieces 12 via a process known as sintering.

Following the above discussed conditioning process, a hard outer coating is applied to the cured/sintered soft coating of the pieces 12. Application of this hard outer coating may occur in a typical batch coating mixer.

By way of exemplary embodiment, the following exemplary compositions of the liquid material 49 and powder material 66, and exemplary composition/sizing of pieces 12 should be noted:

### Piece Size

| Initial Core Weight | 1.0-3.0 gr |
|---|---|
| Target Weight Gain | 5-30% |

By way of exemplary embodiment, the following exemplary conditions of the system 10 should also be noted:

### First Rotating Drum

| Diameter | 0.40-1.20 | m |
|---|---|---|
| Length | 0.20-1.0 | m |
| Drum Volume | 0.025-1.13 | m³ |
| Drum Inclination | 1-5° | |
| Operating Speed | 10~40 | RPM |
| Average Product Residence Time | 20-200 | seconds |

### Second Rotating Drum

| Diameter | 0.8-2.5 | m |
|---|---|---|
| Length | 0.45-4.0 | m |
| Drum Volume | 0.226-19.635 | m³ |
| Drum Inclination | 1-5° | |
| Operating Speed | 4~20 | RPM |
| Average Product Residence Time | 10-30 | minutes |

In addition, and similarly to the feed device 14, it should be noted that drum rotational speed, drum inclination, scalper actuation, actuation and speed of the elevator conveyor 76, and the desirable depth to which the pieces 12 accumulate within the drums are controllable via a computer micro-processor or micro-processors in communication with the various components of the drum arrangements 16a, 16b individually or as a whole. In fact, one or more computer(s) may or may not control/communicate with an entirety of the system 10.

Furthermore, the drums 18 and 20 are controllable within the system 10 such that the first drum 18 and second drum 20 may rotate at different speeds and be disposed at different inclinations. As both drum rotational speed and drum inclination can effect residence time within the drums, differences in either the rotational speeds of the drums or the inclination of the drums may contribute to or be solely responsible for the longer residence time of the pieces 12 in the second drum volume 42 than the first drum volume 40.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for continuously coating individual pieces of confectionary product, the system comprising:
a product feed device;
at least one drum coating arrangement configured to receive the individual pieces of confectionary product from said product feed device, said drum coating arrangement including a first rotating drum rotatable about a first drum axis and a second rotating drum rotatable about a second drum axis;
a first drum volume defined by said first rotating drum; and
a second drum volume defined by said second rotating drum, said first drum volume being communicable with said second drum volume,
wherein said drum coating arrangement is configured such that the confectionary product has a longer residence time in said second drum volume than said first drum volume.

2. The system of claim 1, wherein said second drum volume is greater than said first volume, said larger second drum volume allowing the pieces of confectionary product to achieve said longer residence time in said second drum volume than said first drum volume.

3. The system of claim 1, wherein said first rotating drum is configured to apply a liquid material to the individual pieces of confectionary product and said second rotating drum is configured to apply a dry powder material to the individual pieces of confectionary product.

4. The system of claim 1, wherein said first rotating drum receives the individual pieces of confectionary product from said product feed and said second rotating drum receives the individual pieces of confectionary product from said first rotating drum, said drum coating arrangement being positioned on an incline, with a highest point disposed at a product input of said first rotating drum and a lowest point disposed at a product output of said second rotating drum, said incline allowing the individual pieces of confectionary product to move through said drum coating arrangement.

5. The system of claim 1, wherein said second rotating drum includes a greater diameter than said first rotating drum, said first drum volume and said second drum volume being communicable via insertion of an output end of said first rotating drum into an input end of said second rotating drum, said insertion allowing the individual pieces of confectionary product to flow from said first drum volume to said second drum volume.

6. The system of claim 1, wherein said second rotating drum includes a greater length than said first rotating drum.

7. The system of claim 1, wherein said first rotating drum is affixed to said second rotating drum via a locking mechanism contacting an outer surface of each of said first rotating drum and said second rotating drum.

8. The system of claim 3, wherein said liquid material is fed into said first drum volume via a nozzle inserted into a product input opening at a product input end of said first rotating drum.

9. The system of claim 8, wherein said nozzle is configured to supply said liquid material via at least one of a drip, drizzle, and spray of said liquid material into said first drum volume.

10. The system of claim 8, wherein said nozzle is configured for adjustability of liquid material output position along a length of said first drum volume.

11. The system of claim 5, wherein insertion of said output end of said first rotating drum into said input end of said second rotating drum creates an annulus at an overlap of said first rotating drum and said second rotating drum, said dry powder material being fed into said second rotating drum volume via a powder tube inserted into said second drum volume through said annulus.

12. The system of claim 11, wherein said powder tube is configured for adjustability of dry powder material output position along a length of said second drum volume.

13. The system of claim 1, wherein a weir plate is disposed between said first drum volume and said second drum volume, said weir plate being adjustably positioned relative to said first drum volume and said second drum volume, so as to control product flow from said first drum volume to said second drum volume.

14. The system of claim 1, wherein said first rotating drum includes a release assist bar inserted into said first drum volume from an opening at an output end of said first rotating drum, said release assist bar being disposed substantially parallel to said first drum axis in proximity to an inner surface of said first rotating drum, said release assist bar being configured to dislodge the pieces of confectionary product that adhere to said inner surface of said rotating first rotating drum via said proximity to said inner surface.

15. The system of claim 1, wherein at least one of an inner surface of said first rotating drum and an inner surface of said second rotating drum include ribs.

16. The system of claim 1, wherein said product feed device is configured to control an amount of the individual pieces of confectionary product entering said drum coating arrangement by accumulating the product at a desired weight and depth in a product bed prior to entry into said drum coating arrangement.

17. The system of claim 1, wherein said at least one drum coating arrangement is multiple drum arrangements arranged in series and each including said first rotating drum and said second rotating drum.

18. The system of claim 17, further including a conveyor between said multiple drum coating arrangements, said conveyor including a vibrating portion configured to remove excess dry powder material from the individual pieces of confectionary product.

19. The system of claim 18, wherein said vibrating portion includes openings disposed in staggered alignment.

20. The system of claim 1, wherein said first rotating drum and said second rotating drum are rotatable at different speeds.

21. The system of claim 1, wherein said first rotating drum and said second rotating drum are independently inclinable.

22. A method for continuously coating individual pieces of confectionary product, the method comprising:
feeding the individual pieces of confectionary product from a product feed device into at least one drum coating arrangement, said drum coating arrangement including a first rotating drum and a second rotating drum;
transporting the individual pieces of confectionary product through a first drum volume defined by said first rotating drum, said transporting through said first drum volume occurring in a first residence time;
applying a first material to the individual pieces of confectionary product during said first residence time;
transferring the individual pieces of confectionary product from said first drum volume to a second drum volume defined by said second rotating drum;
transporting the individual pieces of confectionary product through said second drum volume, said transporting through said second drum volume occurring in a second residence time, said second residence time being longer than said first residence time; and
applying a second material to the individual pieces of confectionary product during said second residence time.

23. The method of claim 22, wherein said first material is a liquid material and said second material is a dry powder material.

24. The method of claim 23, further including binding said liquid material to the individual pieces of confectionary product via said applying of said liquid material, and binding said dry powder material to said liquid material via said applying of said dry powder material.

25. The method of claim 22, further including providing a soft outer coating material on the individual pieces of confectionary via said liquid material and said dry powder material bound to said liquid material.

26. The method of claim 22, wherein said transporting occurs via a positioning of said drum coating arrangement on an incline, said drum coating arrangement including a highest point disposed at a product input of said first rotating drum and a lowest point disposed at a product output of said second rotating drum.

27. The method of claim 22, wherein said second drum volume is larger than said first volume, said larger second drum volume allowing said second residence time being longer than said first residence time.

28. The method of claim 22, wherein said second rotating drum includes a greater diameter than said first rotating drum, said first drum volume and said second drum volume being communicable via insertion of an output end of said first rotating drum into an input end of said second rotating drum, said insertion allowing the individual pieces of confectionary product to flow from said first drum volume to said second drum volume.

29. The method of claim 22, wherein said second rotating drum includes a greater length than said first rotating drum.

30. The method of claim 22, further including affixing said first rotating drum to said second rotating drum via a locking mechanism in contact with an outer surface of each of said first rotating drum and said second rotating drum.

31. The method of claim 23, wherein said applying of said liquid material includes at least one of dripping, drizzling, and spraying said liquid material into said first drum volume via a nozzle inserted into a product input opening at a product input end of said first rotating drum.

32. The method of claim 31, further including adjusting said nozzle to a desirable liquid material output position along a length of said first drum volume.

33. The method of claim 28, wherein said insertion of said output end of said first rotating drum into said input end of said second rotating drum creates an annulus at an overlap of said first rotating drum and said second rotating drum, said supplying of said dry powder material into said second drum volume occurring via a powder feed tube inserted into said second drum volume through said annulus.

34. The method of claim 33, further including adjusting said powder tube to a desired dry powder material output position along a length of said second rotating drum volume.

35. The method of claim 22, further including controlling product flow from said first drum volume to said second drum volume via a weir plate disposed between said first drum volume and said second drum volume, said weir plate being adjustably positioned relative to said first drum volume and said second drum volume.

36. The method of claim 22, further including dislodging the product pieces that adhere to an inner surface of said rotating first rotating drum via a release assist bar inserted into said first drum volume from an opening at an output end of said first rotating drum, said release assist bar being disposed substantially parallel to an axis of said first rotating drum in proximity to said inner surface of said first rotating drum.

37. The method of claim 22, further including controlling an amount of the individual pieces of confectionary product entering said drum coating arrangement by accumulating the product at a desired weight and depth in a product bed of said product feed device prior to entry into said drum coating arrangement.

38. The method of claim 22, wherein said at least one drum coating arrangement is multiple drum arrangements arranged in series and each including said first rotating drum and said second rotating drum.

39. The method of claim 38, further including conveying the individual pieces of confectionary product between said multiple drum coating arrangements, said conveying including a vibrating the individual pieces of confectionary product to remove excess dry powder material.

40. The method of claim 22, further including rotating said first rotating drum and said second rotating drum at different speeds.

41. The method of claim 22, further including inclining said first drum and said second drum at different angles.

42. The method of claim 25, further including conditioning the individual pieces of confectionary with said soft outer coating at a reduced temperature and humidity relative to a temperature and humidity of an ambient environment of the drum coating arrangement, said conditioning occurring for at least 18 hours.

43. The method of claim 42, further including applying a hard outer coating on the individual pieces of confectionary product after said conditioning, said applying of said hard outer coating occurring in a batch coating mixer.
